(19) United States
(12) Patent Application Publication
(10) Pub. No.: US 2022/0155263 A1
(43) Pub. Date: May 19, 2022

(54) SOUND ANOMALY DETECTION USING DATA AUGMENTATION

(71) Applicant: INTERNATIONAL BUSINESS MACHINES CORPORATION, Armonk, NY (US)

(72) Inventors: Tadanobu Inoue, Yokohama (JP); Phongtharin Vinayavekhin, Taito-ku (JP); Shu Morikuni, Koutouku (JP); Michiaki Tatsubori, Oiso (JP); Ryuki Tachibana, Setagaya-ku (JP)

(21) Appl. No.: 16/952,398

(22) Filed: Nov. 19, 2020

(51) Int. Cl. G01N 29/44; G01N 29/14; G06N 3/08; G06N 7/00

(52) U.S. Cl. CPC G01N 29/4481; G01N 29/14; G06N 7/005; G06N 3/08; G01N 29/449

(57) ABSTRACT

Methods and systems for anomaly detection include training a neural network model to identify a form of data augmentation that has been performed on a waveform. Multiple forms of data augmentation are performed on a sample waveform to generate data augmentation samples. The data augmentation samples are classified with the neural network model. An anomaly score is determined based on the classification of the data augmentation samples.

The following disclosure(s) are submitted under 35 U.S.C. § 102(b)(1)(A):

### DISCLOSURE(S):

DETECTION OF ANOMALOUS SOUNDS FOR MACHINE CONDITION MONITORING USING CLASSIFICATION CONFIDENCE, Tadanobu Inoue, Phongtharin Vinayavekhin, Shu Morikuni, Shiqiang Wang, Tuan Hoang Trong, David Wood, Michiaki Tatsubori, Ryuki Tachibana, made available Jul. 1, 2020.

DETECTION OF ANOMALOUS SOUNDS FOR MACHINE CONDITION MONITORING USING CLASSIFICATION CONFIDENCE (paper), T. Inoue, P. Vinayavekhin, S. Morikuni, S. Wang, T. H. Trong, D. Wood, M. Tatsubori, R. Tachibana, made available Nov. 2, 2020.

DETECTION OF ANOMALOUS SOUNDS FOR MACHINE CONDITION MONITORING USING CLASSIFICATION CONFIDENCE (presentation), Tadanobu Inoue, Phongtharin Vinayavekhin, Shu Morikuni, Shiqiang Wang, Tuan Hoang Trong, David Wood, Michiaki Tatsubori, Ryuki Tachibana, made available Nov. 2, 2020.

### BACKGROUND

The present invention generally relates to detection of anomalies in sound data, and, more particularly, to using data augmentation on sound samples to distinguish anomalous sound data from normal sound data.

Anomaly detection seeks to find unusual samples in audio data. For example, using a dataset of audio samples that represent “normal” data for training a model, anomalous input audio data may be recognized with the trained model. Examples of attempts at performing audio anomaly detection include reconstruction, where anomalies may be detected from reconstruction errors of a trained autoencoder or generative adversarial network, feature-learning, where a feature extraction model maps normal data into a small area of a feature space, classification, where a classifier is used to find samples that are out of an expected distribution, and geometric transformation, where a classifier is trained to infer geometric transformations of image data.

Each of these examples faces respective challenges. Geometric transformation, for example, is designed for images, and a naïve application of geometric transformation principles to audio samples performs poorly.

### SUMMARY

A method for anomaly detection includes training a neural network model to identify a form of data augmentation that has been performed on a waveform. Multiple forms of data augmentation are performed on a sample waveform to generate data augmentation samples. The data augmentation samples are classified with the neural network model. An anomaly score is determined based on the classification of the data augmentation samples.

A method for anomaly detection includes training a neural network model to identify a form of data augmentation that has been performed on a waveform. Multiple forms of data augmentation are performed on a sample waveform, including differing types of data augmentation and differing degrees of each type of data augmentation, to generate a plurality of data augmentation samples. The data augmentation samples are segmented into respective sets of segments, separated from one another by a hop size. The data augmentation sample segments are classified with the neural network model to identify a form of data augmentation that has been performed on each of the segments. An anomaly score is determined based on the classification of the data augmentation sample segments.

A system for anomaly detection includes a hardware processor and a memory that stores computer program code. When the computer program code is executed by the hardware processor, it implements a neural network model that identifies a form of data augmentation that has been performed on a waveform, a model trainer that trains the neural network model, a data augmenter that performs multiple forms of data augmentation on a sample waveform to generate data augmentation samples, and an anomaly detector that determines an anomaly score based on the classification of the data augmentation samples. The neural network model classifies the data augmentation samples.

A system for anomaly detection includes a hardware processor and a memory that stores computer program code. When the computer program code is executed by the hardware processor, it implements a neural network model that identifies a form of data augmentation that has been performed on a waveform, a model trainer that trains the neural network model, a data augmenter that performs multiple forms of data augmentation on a sample waveform to generate data augmentation samples and that segments the data augmentation samples into respective sets of segments, and an anomaly detector that determines an anomaly score based on the classification of the data augmentation samples. The multiple forms of data augmentation include differing types of data augmentation and differing degrees of each type of data augmentation. The segments are separated from one another by a hop size. The neural network model classifies the data augmentation samples to identify a form of data augmentation that has been performed on each of the data augmentation sample segments.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1 is a diagram showing a variety of different forms of data augmentation being performed on an input waveform sample, including distinct types of data augmentation that are performed to differing degrees, in accordance with an embodiment of the present invention;

FIG. 2 is a diagram showing segmentation of an input waveform, in accordance with an embodiment of the present invention;

FIG. 3 is a block/flow diagram of a method of detecting an anomaly and performing a responsive action, in accordance with an embodiment of the present invention;

FIG. 4 is a block/flow diagram of a method of training a classifier to detect forms of data augmentation that are performed on waveform samples, in accordance with an embodiment of the present invention;

FIG. 5 is a block/flow diagram of a method of detecting anomalies using data augmentation classification, in accordance with an embodiment of the present invention;

FIG. 6 is a block diagram of an anomaly detection and response system that uses data augmentation classification, in accordance with an embodiment of the present invention;

FIG. 7 is a high-level diagram of neural network layers that may be used in classifying data augmentation, in accordance with an embodiment of the present invention;

FIG. 8 is a diagram of a neural network architecture that may be used in classifying data augmentation, in accordance with an embodiment of the present invention; and

FIG. 9 is a diagram of a neural network classifier that may be used to classify data augmentation in waveform samples, in accordance with an embodiment of the present invention.

### DETAILED DESCRIPTION

To detect anomalous sound data, sound augmentation may be used on an acoustic dataset, using a variety of different augmentation types. A machine learning model may then be trained to classify input sound segments according to what kind of data augmentation was applied. During anomaly detection, input sound data is augmented in the same fashion as the training dataset. The machine learning model is then used to classify the input sound data in accordance with the different kinds of data augmentation. An anomaly score can then be generated, on the basis of a confidence with which the augmented input data is classified to trained augmentation type classes. Anomalous sound data may generally have a lower confidence value and higher anomaly score than normal sound data.

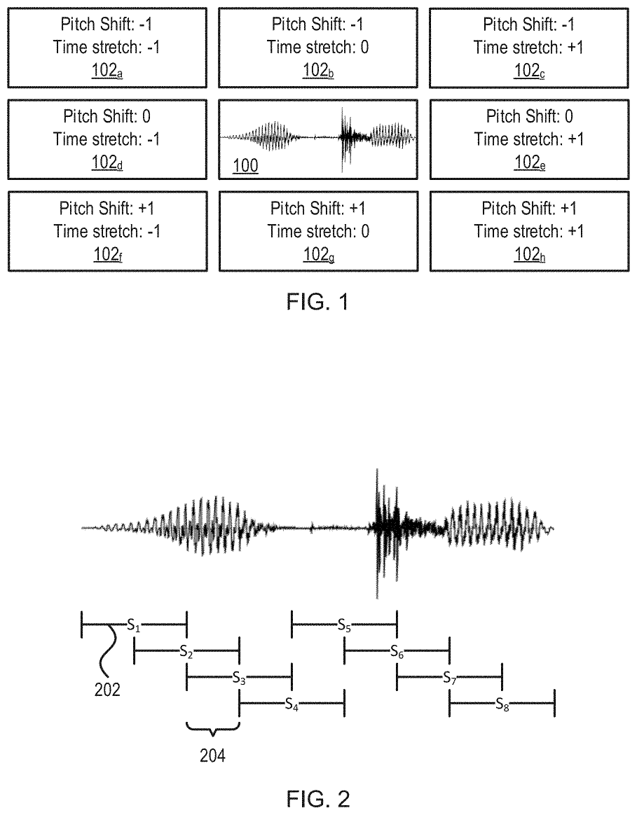

Referring now to FIG. 1, a diagram is shown that illustrates the application of a variety of different data augmentation processes to a sound clip 100. In this example, two kinds of data augmentation are performed to create multiple augmented samples. This particular example shows a pitch shift and a time stretch being performed, each to three different degrees. Thus, nine samples are shown, including the original input sample 100, and eight augmented samples 102ₐ-102ₕ, each with a different respective degree (e.g., a magnitude selected from −1, 0, +1).

It should be understood that any number and type of data augmentation processes may be performed, with any appropriate number of degrees. Exemplary types of sound data augmentation include pitch shift, time stretch, low/high pass filters, overlapping noise sounds, temporal shift, decomposition of sounds into harmonic and percussive components, shuffling time series order of sound segments, and averaging sounds. While two types of data augmentation are shown, with three degrees each, to product a field of nine outputs, any number of data augmentation types may be used, with any appropriate number of degrees, to generate a set of augmented samples of any appropriate size.

Referring now to FIG. 2, the input sample 100 may be divided into a set of segments 202. The segments 202 may all have a same length, or may have varying lengths. A starting time of each subsequent segment 202 may be separated from a starting time of a previous segment 202 by a hop size 204. Thus, the segments 202 may overlap with one another to varying degrees, according to the hop size 204. The segment length and the hop size are hyperparameters that can be tuned to maximize anomaly detection performance. As an example of one practical implementation, a sample size of ten seconds may have segment lengths of 2-3 seconds, with a 50% hop size ratio relative to the segment length.

The input sample 100 may be of any appropriate length, and one sample may vary in length from the next. Additionally, some types of data augmentation (e.g., time stretching) will affect the length of the sample. Using a consistent segment size helps to provide uniform samples to a classifier, regardless of the length of the input. Thus, for an input sample that is ten seconds long, data augmentation may produce a set of samples that vary from about 9 seconds to about 11 seconds. The segments 202 in this example may have a length of about three seconds, with a hop size of about one second. Thus, each of the augmented samples may have a different number of segments 202 associated with it.

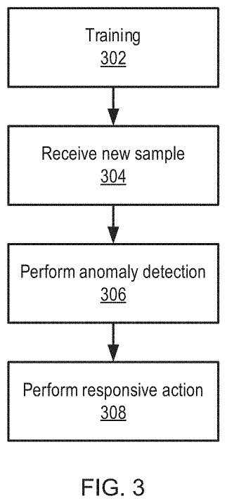

Referring now to FIG. 3, a method of detecting and responding to anomalous audio is shown. Training is performed in block 302. The training uses a machine learning model, such as one implemented by an artificial neural network (ANN). Training takes an input dataset, which includes a variety of “normal” sound samples, and performs N types of data augmentation on each sample. Each sample is broken into multiple sound segments. The segments are used to train the machine learning model.

While it is specifically contemplated that the dataset may include sound information that is recorded within the frequency range of human hearing, it should be understood that the present principles may be readily extended to non-audible pressure waves, seismic information, biometric information (e.g., heart rate or brainwaves), vibration, accelerometer data, and any other kind of data that may be converted into a waveform. For example, recorded time series from sensors within a system may be expressed as a waveform, even though sound information may not be involved at all.

The machine learning model may include a set of classifiers, each being trained to recognize a respective data augmentation, or combination of data augmentations, and to output a corresponding probability. The probability reflects the likelihood that an input segment was augmented according to the respective combination of data augmentations. Thus, for example, a classifier that is trained to recognize segments that have undergone a pitch shift with degree −1, and a time stretch with degree +1, will provide a high probability output for normal segments that have undergone those data augmentations, but will provide a lower probability output for segments that have not.

The trained classifier for a particular set of data augmentations may also provide a lower probability output for input segments that actually have undergone the respective combination of data augmentations, but which were generated from anomalous sound date. This may occur, because the anomalous data may behave differently under the data augmentation, as compared to normal sound data. To increase the likelihood that such a mismatch may occur, a variety of different data augmentations and degrees of augmentation may be performed.

The training in block 302 may divide the training dataset into a training subset and a validation subset. As will be described in greater detail below, the training dataset may be used in a backpropagation-style training process, where the machine learning mode's output is compared to an expected output for part of the training data, and error information is propagated back through the model to update it. Once training is completed, the model may further be evaluated against new training information from the validation subset, to evaluate whether the machine learning model has been trained with sufficient generality. The training of block 302 may be repeated and refined until accuracy in classifying the validation subset exceeds a threshold value.

Block 304 receives a new input audio sample. This sample may originate from any source. As with the training dataset, the input audio sample may be audible sound information, or may represent any appropriate waveform that matches the type of audio information used for training. Thus, the sample may originate from any source that is appropriate for recording the pertinent type of waveform, such as a microphone, seismograph, heartrate monitor, electroencephalogram, etc.

Block 306 performs anomaly detection on the new sample. The anomaly detection outputs an anomaly score for the sample, based on the degree to which data augmentation that is performed on the sample can be correctly classified, and will be described in greater detail below. Once an anomaly has been detected, block 308 performs a responsive action.

Anomaly detection may be used for a variety of applications, such as in equipment fault detection, product defect detection, network intrusion detection, fraud detection, medical diagnosis, and earthquake detection. The responsive action can be used to quickly and automatically respond to any such anomaly, providing a rapid response to new circumstances. For example, anomalies may indicate a product defect in a factory, in which case the faulty product can be diverted from the factory line and can be repaired. Anomalies may also indicate an equipment fault, in which case the factory line may be halted, to repair the equipment and prevent further damage. In some cases, where the anomaly may be addressed automatically, the responsive action may adjust operational parameters of a system to compensate, such as increasing a cooling action when an overheating condition is detected.

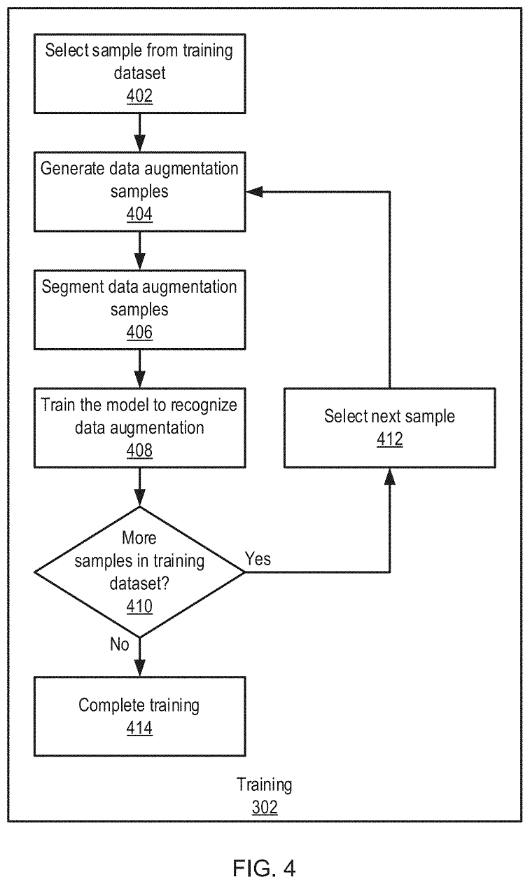

Referring now to FIG. 4, additional detail on training block 302 is shown. Block 402 selects an initial original sample from the training dataset. Block 404 then generates data augmentation samples from the original sample, for example by using different types of data augmentation, performed to different degrees. Each data augmentation sample is thus characterized by the types of data augmentation that are performed on it, and the respective degree of each type of data augmentation. One data augmentation sample may include a degree of zero for each type of data augmentation, and may thus be identical to the original sample.

Block 406 then segments the data augmentation samples, for example using the hop size to step through each data augmentation sample and to select segments of a fixed length. The data augmentation segments are then used by block 408 to train a machine learning model to recognize the types and degrees of data augmentation.

Training may make use of a loss function to characterize the difference between the output of the model and the expected output of the model. The loss may include, for example, a softmax loss and a center loss, where the former characterizes descriptiveness and the latter characterizes compactness. The loss function may thus be expressed as:

L=Lₛ+λL_{c}

where Lₛ is the softmax loss, L_{c} is the center loss, and λ is a parameter that determines a weight between the components of the loss. The center loss may be used to map normal input data to a minimized volume hyperspace in the latent feature space.

Block 410 determines whether there are further original samples in the training dataset. If so, block 412 selects the next sample, and processing returns to block 404. If not, the training is complete at block 414. The model may be tested against a validation dataset, and may be repeated if needed.

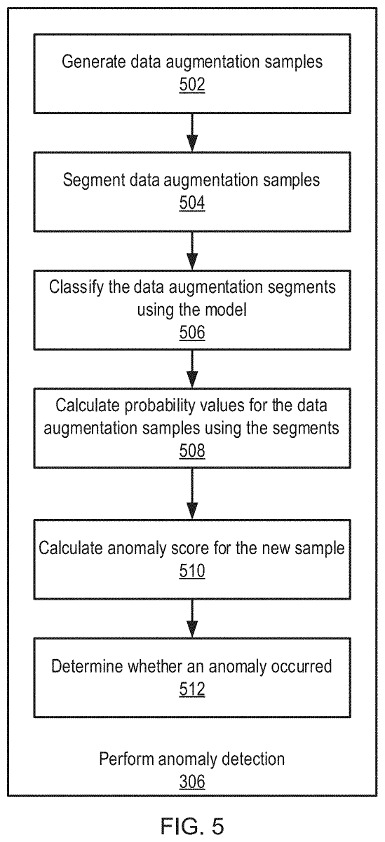

Referring now to FIG. 5, additional detail on the anomaly detection of block 306 is shown. After the new sample is received in block 304, block 502 generates data augmentation samples from the new sample, for example using the same set of data augmentation types and degrees that were used to generate training data augmentation samples in block 404. In some cases, the data augmentation of block 502 need not replicate all of the data augmentation types and degrees used during training. For example, some data augmentation types or degrees may be skipped, to make the inference faster.

After the new data augmentation samples have been generated, block 504 then segments the new data augmentation samples, using the same hop size and segment length as was used to segment the training data augmentation samples in block 406. Segmenting the sample may improve anomaly detection, because an anomaly may occur in only a small part of a larger sample. Furthermore, dividing a sample into multiple segments increases the amount of training data that is available, which can improve the accuracy of a classifier.

Block 506 uses the trained model to classify the data augmentation segments. Each segment is classified according to the type and degree of data augmentation that was performed, with an associated probability score being generated for segment. For example, a softmax probability may be determined for each segment.

Block 508 then determines an average value over the probabilities of the segments of each respective new data augmentation sample. Thus, each new data augmentation sample will have an associated score that is the average of the probabilities of each of its component segments. Block 510 then determines an anomaly score for the new sample. For example, this score may be determined as:

$$s ( x ) = 1 - \frac{1}{k} {\sum }_{j = 0}^{k - 1} {[ y ( {T}_{j} ( x ) ) ]}_{j} \qquad$$

where x is the new sample, Tⱼ(x) is the output of performing the j^{th} combination of data augmentation types and degrees on the new sample x, y(⋅) is the output of the classifier that is used to determine what type and degree of data augmentation was performed on the new data augmentation sample, and k is a total number of combinations of data augmentation types and degrees. In particular, the value of y(⋅) may be the averaged probability of the segments for the data augmentation sample. For example, following the illustration of FIG. 1, k may be 9.

Once the anomaly score for the new sample has been determined by block 510, block 512 uses the anomaly score to determine whether the new sample represents an anomaly. For example, this may include comparing the anomaly score to a threshold value, with above-threshold anomaly scores indicating that an anomaly has occurred, and with at- or below-threshold anomaly scores indicating that no anomaly has occurred.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), FPGAs, and/or PLAs.

These and other variations of a hardware processor subsystem are also contemplated in accordance with embodiments of the present invention.

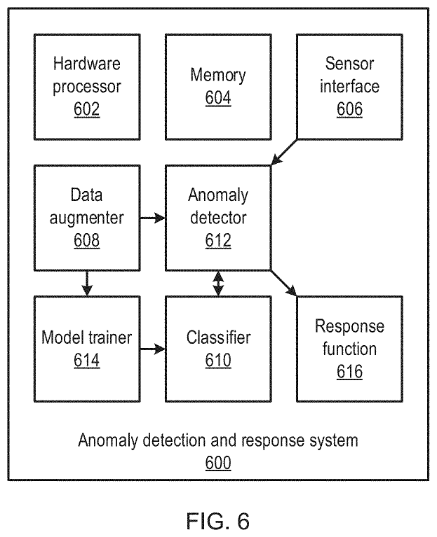

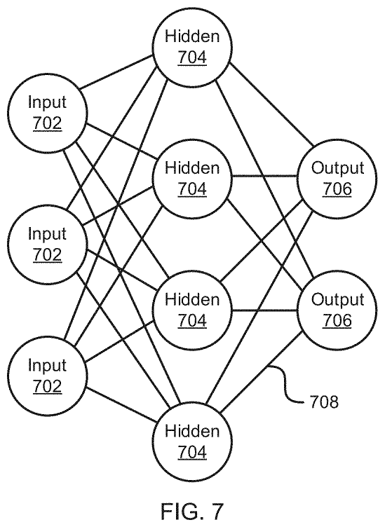

Referring now to FIG. 6, an anomaly detection and response system 600 is shown. The system 600 includes a hardware processor 602 and memory 604. A sensor interface 606 provides communications with one or more sensors that may, for example, include a microphone that collects audio data, or may alternatively be any sensor or combination of sensors that provide a waveform or time series output.

A classifier 610 is trained by a model trainer 614, and may be implemented as any appropriate machine learning model, such as an ANN. A data augmenter 608 is used by the model trainer 614 to perform data augmentation on each original sample waveform from a training dataset, for example using multiple types and degrees of data augmentation, to generate sets of data augmentation samples. The classifier 610 is trained to recognize the type and degree of data augmentation that has been applied to a given segment of a sample.

An anomaly detector 612 receives a new sample from the sensor interface 606 and uses the data augmenter 608 to generate data augmentation samples. The classifier 610 is then used to determine what type and degree of data augmentation was performed on each of the data augmentation samples, generating respective probabilities for each combination of augmentation type and degree. The anomaly detector uses these probabilities to generate an anomaly score for the new sample, and then uses the anomaly score to determine whether the new sample represents an anomaly.

A response function 616 is triggered by the detection of an anomaly. The response function 616 may include any appropriate action that corrects, reports, or otherwise addresses the detected anomaly.

Referring now to FIG. 7, a generalized diagram of an ANN is shown. As noted above, the classifier 610 may be implemented as an ANN. An ANN is an information processing system that is inspired by biological nervous systems, such as the brain. The key element of ANNs is the structure of the information processing system, which includes a large number of highly interconnected processing elements (called “neurons”) working in parallel to solve specific problems. ANNs are furthermore trained in-use, with learning that involves adjustments to weights that exist between the neurons. An ANN is configured for a specific application, such as pattern recognition or data classification, through such a learning process.

ANNs demonstrate an ability to derive meaning from complicated or imprecise data and can be used to extract patterns and detect trends that are too complex to be detected by humans or other computer-based systems. The structure of a neural network is known generally to have input neurons 702 that provide information to one or more “hidden” neurons 704. Connections 708 between the input neurons 702 and hidden neurons 704 are weighted and these weighted inputs are then processed by the hidden neurons 704 according to some function in the hidden neurons 704, with weighted connections 708 between the layers. There can be any number of layers of hidden neurons 704, and as well as neurons that perform different functions. There exist different neural network structures as well, such as convolutional neural network, maxout network, etc. Finally, a set of output neurons 706 accepts and processes weighted input from the last set of hidden neurons 704.

This represents a “feed-forward” computation, where information propagates from input neurons 702 to the output neurons 706. Upon completion of a feed-forward computation, the output is compared to a desired output available from training data. The error relative to the training data is then processed in “feed-back” computation, where the hidden neurons 704 and input neurons 702 receive information regarding the error propagating backward from the output neurons 706. Once the backward error propagation has been completed, weight updates are performed, with the weighted connections 708 being updated to account for the received error. This represents just one variety of ANN.

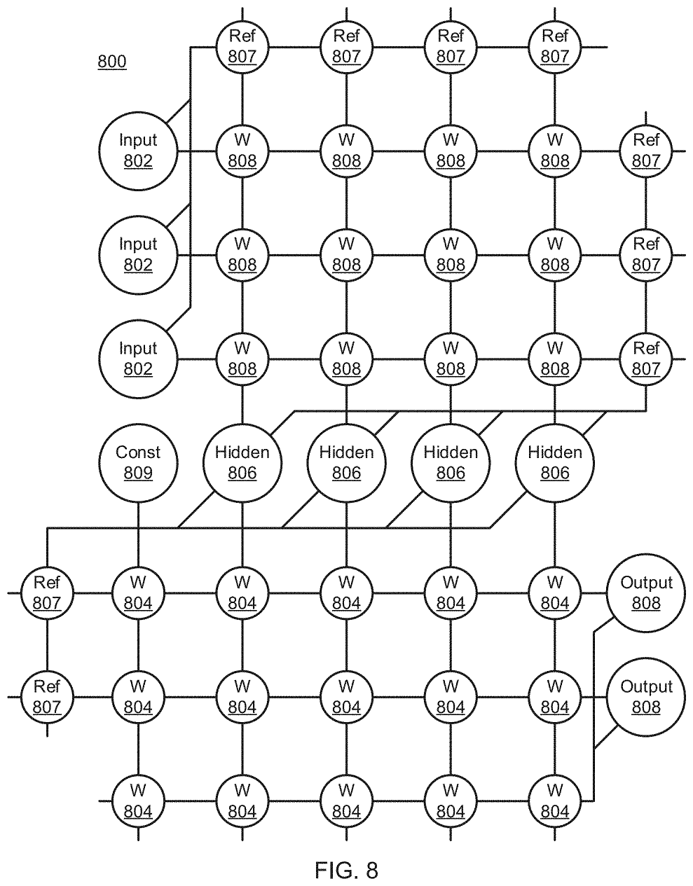

Referring now to FIG. 8, an ANN architecture 800 is shown, corresponding to the generalized structure of FIG. 7. It should be understood that the present architecture is purely exemplary and that other architectures or types of neural network can be used instead. In particular, while a hardware embodiment of an ANN is described herein, it should be understood that neural network architectures can be implemented or simulated in software. The hardware embodiment described herein is included with the intent of illustrating general principles of neural network computation at a high level of generality and should not be construed as limiting in any way.

Furthermore, the layers of neurons described below and the weights connecting them are described in a general manner and can be replaced by any type of neural network layers with any appropriate degree or type of interconnectivity. For example, layers can include convolutional layers, pooling layers, fully connected layers, softmax layers, or any other appropriate type of neural network layer. Furthermore, layers can be added or removed as needed and the weights can be omitted for more complicated forms of interconnection.

During feed-forward operation, a set of input neurons 802 each provide an input voltage in parallel to a respective row of weights 804. In the hardware embodiment described herein, the weights 804 each have a settable resistance value, such that a current output flows from the weight 804 to a respective hidden neuron 806 to represent the weighted input. In software embodiments, the weights 804 can simply be represented as coefficient values that are multiplied against the relevant neuron outputs.

Following the hardware embodiment, the current output by a given weight 804 is determined as I=v/r, where V is the input voltage from the input neuron 802 and r is the set resistance of the weight 804. The current from each weight adds column-wise and flows to a hidden neuron 806. A set of reference weights 807 have a fixed resistance and combine their outputs into a reference current that is provided to each of the hidden neurons 806. Because conductance values can only be positive numbers, some reference conductance is needed to encode both positive and negative values in the matrix. The currents produced by the weights 804 are continuously valued and positive, and therefore the reference weights 807 are used to provide a reference current, above which currents are considered to have positive values and below which currents are considered to have negative values. The use of reference weights 807 is not needed in software embodiments, where the values of outputs and weights can be precisely and directly obtained. As an alternative to using the reference weights 807, another embodiment can use separate arrays of weights 804 to capture negative values.

The hidden neurons 806 use the currents from the array of weights 804 and the reference weights 807 to perform some calculation. The hidden neurons 806 then output a voltage of their own to another array of weights 804. This array performs in the same way, with a column of weights 804 receiving a voltage from their respective hidden neuron 806 to produce a weighted current output that adds row-wise and is provided to the output neuron 808.

It should be understood that any number of these stages can be implemented, by interposing additional layers of arrays and hidden neurons 806. It should also be noted that some neurons can be constant neurons 809, which provide a constant output to the array. The constant neurons 809 can be present among the input neurons 802 and/or hidden neurons 806 and are only used during feed-forward operation.

During back propagation, the output neurons 808 provide a voltage back across the array of weights 804. The output layer compares the generated network response to training data and computes an error. The error is applied to the array as a voltage pulse, where the height and/or duration of the pulse is modulated proportional to the error value. In this example, a row of weights 804 receives a voltage from a respective output neuron 808 in parallel and converts that voltage into a current which adds column-wise to provide an input to hidden neurons 806. The hidden neurons 806 combine the weighted feedback signal with a derivative of its feed-forward calculation and stores an error value before outputting a feedback signal voltage to its respective column of weights 804. This back propagation travels through the entire network 800 until all hidden neurons 806 and the input neurons 802 have stored an error value.

During weight updates, the input neurons 802 and hidden neurons 806 apply a first weight update voltage forward and the output neurons 808 and hidden neurons 806 apply a second weight update voltage backward through the network 800. The combinations of these voltages create a state change within each weight 804, causing the weight 804 to take on a new resistance value. In this manner the weights 804 can be trained to adapt the neural network 800 to errors in its processing. It should be noted that the three modes of operation, feed forward, back propagation, and weight update, do not overlap with one another.

As noted above, the weights 804 can be implemented in software or in hardware, for example using relatively complicated weighting circuitry or using resistive cross point devices. Such resistive devices can have switching characteristics that have a non-linearity that can be used for processing data. The weights 804 can belong to a class of device called a resistive processing unit (RPU), because their non-linear characteristics are used to perform calculations in the neural network 800. The RPU devices can be implemented with resistive random access memory (RRAM), phase change memory (PCM), programmable metallization cell (PMC) memory, or any other device that has non-linear resistive switching characteristics. Such RPU devices can also be considered as memristive systems.

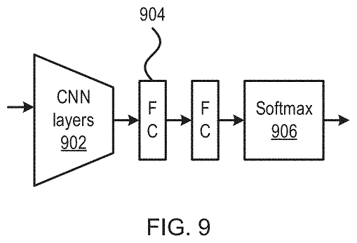

Referring now to FIG. 9, an exemplary structure for a classifier is shown. For implementations that include two types of data augmentation, with three degrees possible for each type, the classifier may be a nine-class classifier. The input may be a spectrogram of sound segment, with the output being a confidence value for each augmentation type. The input may be provided to one or more convolutional neural network (CNN) layers 902. The output of the CNN layers 902 is provided to fully connected layers 904. A softmax layer 906 then generates the confidence values.

In more detail, the layers may be implemented as follows:

Input: Log Mel Spectrogram (ch, freq, time)

CNN[64, k=(7,1)]+BN+ReLU

Max pooling[k=(4,1)]+Dropout(0.2)

CNN[128, k=(10,1)]+BN+ReLU

CNN[256, k=(1,7)]+BN+ReLU

Global max pooling (ch-axis)+Dropout(0.5)

Dense(128)

Dense(class)+Softmax

In the above, “BN” refers to batch normalization, ReLU refers to a rectified linear unit, “max pooling” refers to pooling layers for CNNs, “dropout” refers to a dropout layer, “dense” refers to a densely connected layer, and “Softmax” refers to a softmax layer.

Having described preferred embodiments of sound anomaly detection using data augmentation (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. A computer-implemented method for anomaly detection, comprising:
training a neural network model to identify a form of data augmentation that has been performed on a waveform;
performing multiple forms of data augmentation on a sample waveform to generate a plurality of data augmentation samples;
classifying the data augmentation samples with the neural network model; and
determining an anomaly score based on the classification of the data augmentation samples.

2. The method of claim 1, further comprising segmenting the data augmentation samples into respective sets of segments, separated from one another by a hop size, before classifying the data augmentation samples.

3. The method of claim 2, wherein classifying the data augmentation samples includes classifying the sets of segments to identify a form of data augmentation that has been performed on each of the segments.

4. The method of claim 3, wherein classifying the data augmentation samples includes determining a probability that each form of data augmentation has been performed on each of the data augmentation samples, each probability being determined as an average of probabilities that each segment of the set of segments corresponding to a given data augmentation sample has been subjected to the respective form of data augmentation.

5. The method of claim 1, wherein the multiple forms of data augmentation include one or more types of data augmentation selected from the group consisting of pitch shift, time stretch, low/high pass filters, overlapping noise sounds, temporal shift, decomposition of sounds into harmonic and percussive components, shuffling time series order of sound segments, and averaging sounds.

6. The method of claim 1, wherein the multiple forms of data augmentation include differing degrees of a single type of data augmentation.

7. The method of claim 6, wherein the multiple forms of data augmentation include at least two distinct types of data augmentation, each performed to at least three different degrees, to provide at least nine different forms of combined data augmentation.

8. The method of claim 1, wherein training the neural network model includes performing the multiple forms of data augmentation on training waveforms in a training dataset.

9. The method of claim 1, wherein the sample waveform is an audio waveform.

10. The method of claim 1, further comprising performing a corrective action responsive to the anomaly score.

11. A computer-implemented method for anomaly detection, comprising:
training a neural network model to identify a form of data augmentation that has been performed on a waveform;
performing multiple forms of data augmentation on a sample waveform, including differing types of data augmentation and differing degrees of each type of data augmentation, to generate a plurality of data augmentation samples;
segmenting the data augmentation samples into respective sets of segments, separated from one another by a hop size;
classifying the data augmentation sample segments with the neural network model to identify a form of data augmentation that has been performed on each of the segments; and
determining an anomaly score based on the classification of the data augmentation sample segments.

12. The method of claim 11, wherein the differing types of data augmentation are selected from the group consisting of pitch shift, time stretch, low/high pass filters, overlapping noise sounds, temporal shift, decomposition of sounds into harmonic and percussive components, shuffling time series order of sound segments, and averaging sounds.

13. A non-transitory computer readable storage medium comprising a computer readable program for anomaly detection, wherein the computer readable program when executed on a computer causes the computer to:
train a neural network model to identify a form of data augmentation that has been performed on a waveform;
perform multiple forms of data augmentation on a sample waveform to generate a plurality of data augmentation samples;
classify the data augmentation samples with the neural network model; and
determine an anomaly score based on the classification of the data augmentation samples.

14. A system for anomaly detection, comprising:
a hardware processor; and
a memory that stores computer program code which, when executed by the hardware processor, implements:
a neural network model that identifies a form of data augmentation that has been performed on a waveform;
a model trainer that trains the neural network model;
a data augmenter that performs multiple forms of data augmentation on a sample waveform to generate a plurality of data augmentation samples, wherein the neural network model classifies the data augmentation samples; and
an anomaly detector that determines an anomaly score based on the classification of the data augmentation samples.

15. The system of claim 14, wherein the data augmenter segments the data augmentation samples into respective sets of segments, separated from one another by a hop size, before classifying the data augmentation samples.

16. The system of claim 15, wherein neural network model classifies the sets of segments to identify a form of data augmentation that has been performed on each of the segments.

17. The system of claim 16, wherein the neural network model determines a probability that each form of data augmentation has been performed on each of the data augmentation samples, each probability being determined as an average of probabilities that each segment of the set of segments corresponding to a given data augmentation sample has been subjected to the respective form of data augmentation.

18. The system of claim 14, wherein the multiple forms of data augmentation include one or more types of data augmentation selected from the group consisting of pitch shift, time stretch, low/high pass filters, overlapping noise sounds, temporal shift, decomposition of sounds into harmonic and percussive components, shuffling time series order of sound segments, and averaging sounds.

19. The system of claim 14, wherein the multiple forms of data augmentation include differing degrees of a single type of data augmentation.

20. The system of claim 19, wherein the multiple forms of data augmentation include at least two distinct types of data augmentation, each performed to at least three different degrees, to provide at least nine different forms of combined data augmentation.

21. The system of claim 14, wherein the model trainer performs the multiple forms of data augmentation on training waveforms in a training dataset.

22. The system of claim 14, wherein the computer program code further implements a response function that performs a corrective action responsive to the anomaly score.

23. A system for anomaly detection, comprising:
a hardware processor; and
a memory that stores computer program code which, when executed by the hardware processor, implements:
a neural network model that identifies a form of data augmentation that has been performed on a waveform;
a model trainer that trains the neural network model;
a data augmenter that performs multiple forms of data augmentation on a sample waveform, including differing types of data augmentation and differing degrees of each type of data augmentation, to generate a plurality of data augmentation samples, and that segments the data augmentation samples into respective sets of segments, separated from one another by a hop size, wherein the neural network model classifies the data augmentation samples to identify a form of data augmentation that has been performed on each of the data augmentation sample segments; and
an anomaly detector that determines an anomaly score based on the classification of the data augmentation samples.

24. The system of claim 23, wherein the differing types of data augmentation are selected from the group consisting of pitch shift, time stretch, low/high pass filters, overlapping noise sounds, temporal shift, decomposition of sounds into harmonic and percussive components, shuffling time series order of sound segments, and averaging sounds.

25. The system of claim 23, wherein the sample waveform is an audio waveform.
